(19) United States
(12) Patent Application Publication
(10) Pub. No.: US 2026/0185461 A1
(43) Pub. Date: Jul. 2, 2026

(54) STEAM TURBINE UNIT

(71) Applicant: MITSUBISHI HEAVY INDUSTRIES COMPRESSOR CORPORATION, Hiroshima-shi (JP)

(72) Inventors: Yuki Nakamura, Hiroshima-shi (JP); Shunsuke Fuchiwaki, Hiroshima-shi (JP)

(73) Assignee: MITSUBISHI HEAVY INDUSTRIES COMPRESSOR CORPORATION, Hiroshima-shi (JP)

(21) Appl. No.: 19/326,986

(22) Filed: Sep. 12, 2025

(30) Foreign Application Priority Data
Dec. 26, 2024 (JP) 2024-230067

(51) Int. Cl. F01D 25/04; F01D 25/24

(52) U.S. Cl. CPC F01D 25/04; F01D 25/24

(57) ABSTRACT

A steam turbine unit includes a steam turbine including a rotor, a casing covering the rotor, and a bearing portion, a base plate supporting the steam turbine from below in a vertical direction and fixed on a base, and a plurality of fixing members arranged apart from each other and configured to fix the base plate and the base. The casing includes a steam exhaust port facing downward in the vertical direction and configured to discharge steam to an outside. The bearing portion includes a steam exhaust side bearing portion arranged at a position close to the steam exhaust port in the axial direction. The base plate supports the steam exhaust side bearing portion. Of the plurality of fixing members, two of the fixing members closest in a width direction orthogonal to the vertical direction and the axial direction are arranged at positions shifted in the axial direction with respect to a region supporting the steam exhaust side bearing portion in the base plate.

### CROSS-REFERENCE TO RELATED APPLICATIONS

This application claims the benefit of priority to Japanese Patent Application Number 2024-230067 filed on December 26, 2024. The entire contents of the above-identified application are hereby incorporated by reference.

### TECHNICAL FIELD

The disclosure relates to a steam turbine unit.

### RELATED ART

A steam turbine includes a rotor arranged in a casing, a rotating blade row arranged outside the rotor in a radial direction, and a stator blade row arranged inside the casing in the radial direction. Such a steam turbine is fixed on a base via a base plate called a frame as described in JP 2014-206129 A.

### SUMMARY

For improvement of efficiency, there is an increasing demand for a higher rotor speed in the above-described steam turbine. For a higher rotor speed, the steam turbine needs to be stably supported to a base. Therefore, it is desired to improve the rigidity of support by the base plate arranged between the steam turbine and the base. In particular, the steam turbine tends to have a relatively low strength around a steam exhaust port formed to be a large opening, and thus improvement of rigidity of support for suppressing vibration around the steam exhaust port is demanded in a base plate.

The disclosure has been made to solve the above problem, and an object is to provide a steam turbine unit that can suppress vibration around a steam exhaust port.

In order to solve the above problem, a steam turbine unit according to the disclosure includes: a steam turbine including a rotor extending in an axial direction in which a central axis extends, a casing covering the rotor from an outside in a radial direction with respect to the central axis, and a bearing portion fixed to the casing and rotatably supporting the rotor with respect to the casing; a base plate supporting the steam turbine from below in a vertical direction and fixed on a base; and a plurality of fixing members arranged apart from each other and configured to fix the base plate and the base, in which the casing includes a steam exhaust port facing downward in the vertical direction and configured to discharge steam to an outside, the bearing portion includes a steam exhaust side bearing portion arranged at a position close to the steam exhaust port in the axial direction, the base plate supports the steam exhaust side bearing portion, and of the plurality of fixing members, two of the fixing members closest in a width direction orthogonal to the vertical direction and the axial direction are arranged at positions shifted in the axial direction with respect to a region supporting the steam exhaust side bearing portion in the base plate.

According to the steam turbine unit of the disclosure, vibration can be suppressed around the steam exhaust port.

### BRIEF DESCRIPTION OF DRAWINGS

The disclosure will be described with reference to the accompanying drawings, wherein like numbers reference like elements.

FIG. 1 is a schematic view of a steam turbine unit according to an embodiment of the disclosure as viewed in a width direction.

FIG. 2 is a schematic view illustrating a base plate of the steam turbine unit as viewed obliquely from below.

FIG. 3 is a schematic view illustrating arrangement of a plurality of fixing members with respect to the base plate when viewed from below in a vertical direction.

### DESCRIPTION OF EMBODIMENTS

Hereinafter, embodiments for carrying out a steam turbine unit according to the disclosure will be described with reference to the accompanying drawings. However, the disclosure is not limited to the embodiments.

### Configuration of Steam Turbine Unit

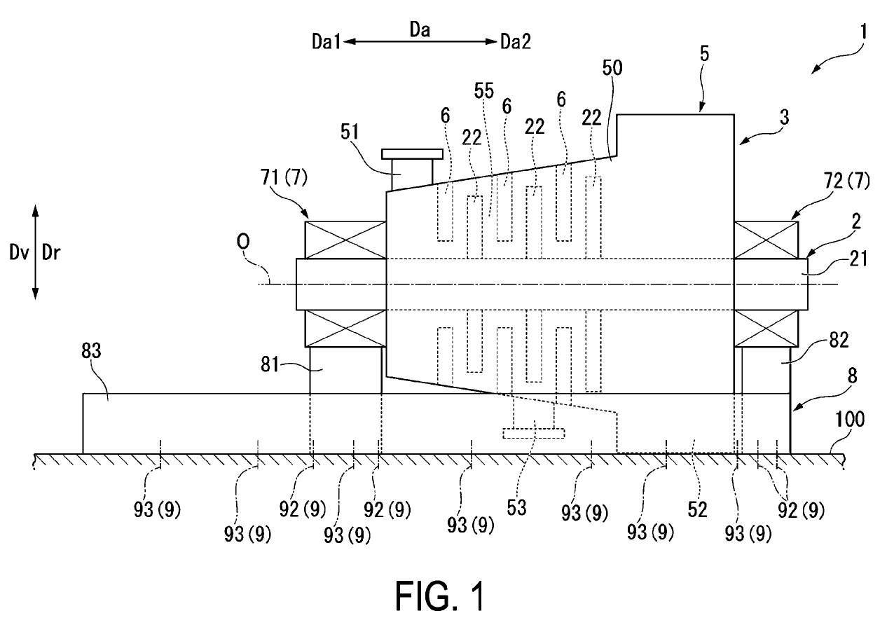

As illustrated in FIG. 1, a steam turbine unit 1 is fixed on a base 100. The base 100 is formed of reinforced concrete, for example. The steam turbine unit 1 in the present embodiment includes a steam turbine 3 and a base plate 8.

### Configuration of Steam Turbine

The steam turbine 3 includes a rotor 2, a casing 5, a stator blade 6, and a bearing portion 7.

### Configuration of Rotor

The rotor 2 extends in an axial direction Da. The rotor 2 extends so as to penetrate the inside of the casing 5 along a central axis O. The rotor 2 includes a rotating shaft 21 and a rotating blade22.

Note that in the present embodiment, a direction in which the central axis O extends is the axial direction Da. The axial direction Da of the rotor 2 is along a horizontal plane. That is, the central axis O extends in the horizontal direction. In the steam turbine 3, the position where an end portion on one side is arranged in the axial direction Da is referred to as a steam inlet side Da1. In the steam turbine 3, the position where the end portion opposite to the end portion on the steam inlet side Da1 is arranged in the axial direction Da is referred to as a steam exhaust side Da2, which is the opposite side to the steam inlet side Da1 in the axial direction Da. A radial direction Dr of the rotor 2 with reference to the central axis O is simply the radial direction Dr. The radial direction Dr is a direction orthogonal to the central axis O, and partially coincides with a vertical direction Dv.

The rotating shaft 21 is formed in a cylindrical shape extending in the axial direction Da about the center. The rotating shaft 21 is supported by the bearing portion 7 with respect to the casing 5 rotatably about the central axis O. The rotating blades 22 are arranged so as to configure a plurality of stages at intervals in the axial direction Da. Each of the rotating blades 22 is fixed so as to extend outward in the radial direction Dr from an outer peripheral surface of the rotating shaft 21.

### Configuration of Casing

The casing 5 is formed so as to cover the rotor 2 from the outside in the radial direction Dr. A main flow path 55 through which high-pressure steam flows is formed inside the casing 5. In the main flow path 55, steam flows from the steam inlet side Da1 toward the steam exhaust side Da2 in the axial direction Da. In the main flow path 55, high-pressure steam flows from the upstream side toward the downstream side with the pressure gradually decreasing. The main flow path 55 is formed in an annular shape around the rotating shaft 21. The main flow path 55 is partially formed by an annular space where the plurality of rotating blades 22 and the stator blades 6 are arranged. The casing 5 of the present embodiment includes a casing main body 50, a steam inlet port 51, a steam exhaust port 52, and a steam extraction port 53.

The casing main body 50 is formed in a tubular shape extending in the axial direction Da about the central axis O. A circulation flow path is formed inside the casing main body 50. The casing main body 50 can be divided up and down in the vertical direction Dv so that a horizontal plane passing through the central axis O is a division plane.

The steam inlet port 51 can supply steam into the casing 5. The steam inlet port 51 is supplied with high-temperature steam generated by a boiler (not illustrated). The high-temperature steam supplied to the steam inlet port 51 is supplied to the main flow path 55 inside the casing main body 50. That is, the steam inlet port 51 is continuous to the most upstream part (closest to the steam inlet side Da1 in the axial direction Da) of the main flow path 55. The steam inlet port 51 is connected to the steam inlet side Da1 in the axial direction Da with respect to the casing main body 50. The steam inlet port 51 opens so as to cause the inside and the outside of the casing main body 50 to communicate with each other. The steam inlet port 51 extends outward in the radial direction Dr from the casing main body 50. The steam inlet port 51 of the present embodiment is formed in a tubular shape extending upward in the vertical direction Dv with respect to the casing main body 50.

The steam exhaust port 52 can discharge steam to the outside of the casing 5. The steam exhaust port 52 discharges the steam flowing from the main flow path 55. That is, the steam exhaust port 52 is continuous to the most downstream part (closest to the most steam exhaust side Da2 in the axial direction Da) of the main flow path 55. The steam exhaust port 52 is connected to the steam exhaust side Da2 in the axial direction Da with respect to the casing main body 50. The steam exhaust port 52 is arranged apart from the steam inlet port 51 on the steam exhaust side Da2 in the axial direction Da. The steam exhaust port 52 opens so as to cause the inside and the outside of the casing main body 50 to communicate with each other. The steam exhaust port 52 is formed as an opening larger than the steam inlet port 51 and the steam extraction port 53. The steam exhaust port 52 extends outward in the radial direction Dr from the casing main body 50. The steam exhaust port 52 of the present embodiment faces downward in the vertical direction Dv with respect to the casing main body 50.

The steam extraction port 53 allows steam to flow inside and outside the casing 5. The steam passing through the steam extraction port 53 and the main flow path 55 can be discharged to the outside of the casing 5. The steam extraction port 53 is connected to the casing main body 50. The steam extraction port 53 extends outward in the radial direction Dr from the casing main body 50. The steam extraction port 53 of the present embodiment faces downward in the vertical direction Dv with respect to the casing main body 50. The steam extraction port 53 is arranged between the steam inlet port 51 and the steam exhaust port 52 in the axial direction Da. The steam extraction port 53 is arranged apart from the steam inlet port 51 and the steam exhaust port 52 in the axial direction Da.

### Configuration of Stator Blade

The plurality of stator blades 6 are fixed to the inside of the casing 5 in the radial direction Dr. The plurality of stator blades 6 form a row arranged in a pipe shape. The plurality of stator blades 6 are fixed to the casing 5 such that the rows are arranged at intervals in the axial direction Da. The stator blades 6 are arranged side by side on the upstream side with respect to the respectively corresponding rotating blades 22 to form a stage.

### Configuration of Bearing Portion

The bearing portion 7 is fixed to the casing 5 and rotatably supports the rotor 2 with respect to the casing 5. The bearing portion 7 can be divided up and down in the vertical direction Dv so that a horizontal plane passing through the central axis O is a division plane. The bearing portion 7 of the present embodiment includes a steam inlet side bearing portion 71 and a steam exhaust side bearing portion 72.

The steam inlet side bearing portion 71 rotatably supports an end portion of the rotating shaft 21 on the steam inlet side Da1 in the axial direction Da. The steam inlet side bearing portion 71 is arranged at a position close to the steam inlet port 51 in the axial direction Da. The steam inlet side bearing portion 71 is arranged on the steam inlet side Da1 in the axial direction Da with respect to the steam inlet port 51. The steam inlet side bearing portion 71 is arranged apart from the steam exhaust side bearing portion 72 in the axial direction Da so as to sandwich the steam exhaust port 52 between the steam exhaust side bearing portion 72 and the steam inlet side bearing portion 71 in the axial direction Da. The steam inlet side bearing portion 71 includes, for example, a journal bearing and a thrust bearing. The steam inlet side bearing portion 71 is fixed to the casing main body 50 on the steam inlet side Da1 in the axial direction Da with respect to the casing main body 50.

The steam exhaust side bearing portion 72 rotatably supports an end portion of the rotating shaft 21 on the steam exhaust side Da2 in the axial direction Da. The steam exhaust side bearing portion 72 is arranged at a position close to the steam exhaust port 52 in the axial direction Da. The steam exhaust side bearing portion 72 is arranged on the steam exhaust side Da2 in the axial direction Da with respect to the steam exhaust port 52. The steam exhaust side bearing portion 72 is arranged apart from the steam inlet side bearing portion 71 on the steam exhaust side Da2 in the axial direction Da so as to sandwich the casing main body 50 between the steam inlet side bearing portion 71 and the steam exhaust side bearing portion 72 in the axial direction Da. The steam exhaust side bearing portion 72 includes, for example, a journal bearing. The steam exhaust side bearing portion 72 is fixed to the casing main body 50 on the steam exhaust side Da2 in the axial direction Da with respect to the casing main body 50.

### Configuration of Base Plate

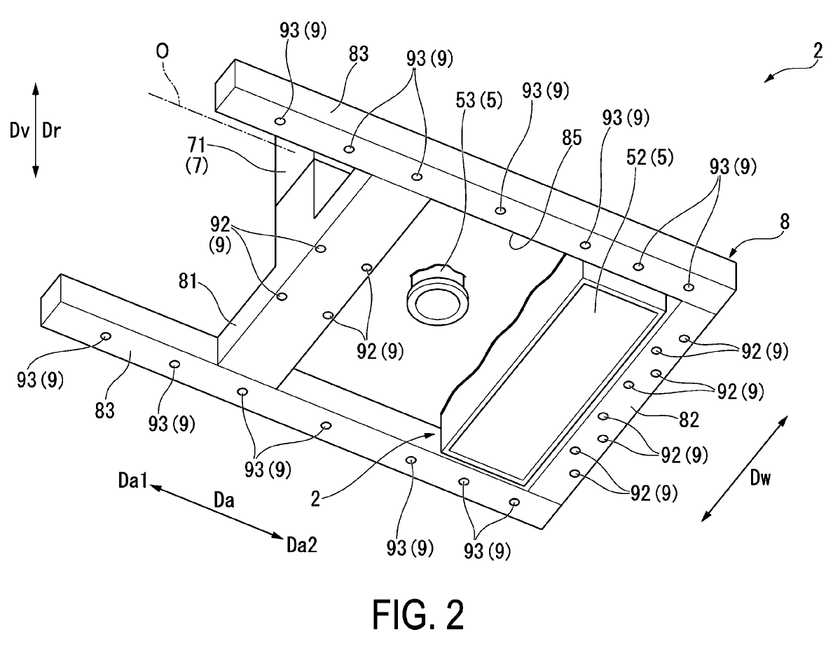

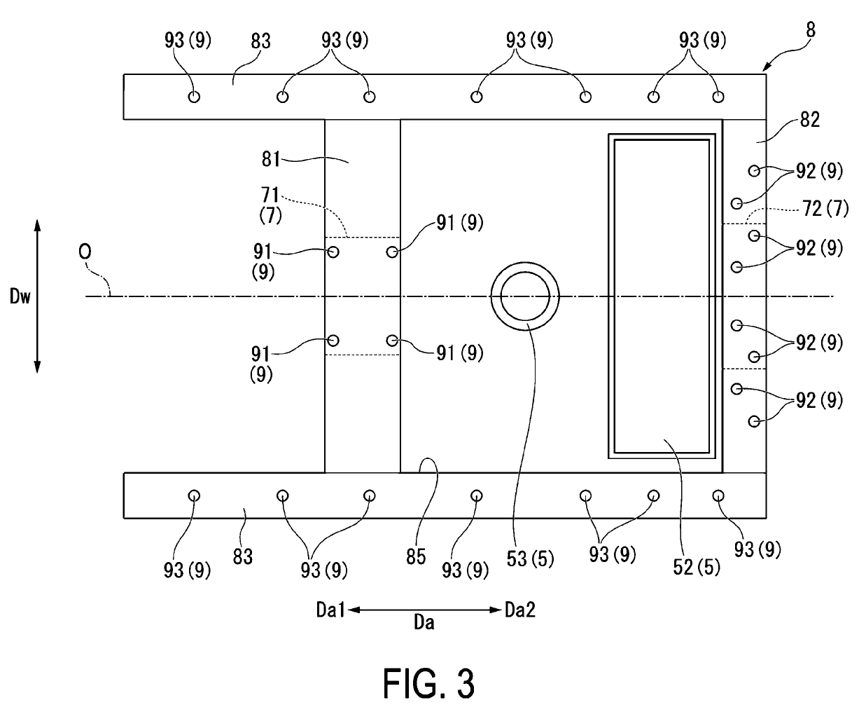

The base plate 8 supports the steam turbine 3 from below in the vertical direction Dv. The base plate 8 is fixed on the base 100. The base plate 8 is fixed also to the steam turbine 3. For example, the base plate 8 is fixed to the steam turbine 3 in a state where movement in the axial direction Da is allowable. On the other hand, the base plate 8 is fixed on the base 100 in an immovable state by the fixing member 9. The base plate 8 supports the bearing portion 7 from below in the vertical direction Dv. The base plate 8 is fixed to the steam inlet side bearing portion 71 and the steam exhaust side bearing portion 72. As illustrated in FIGS. 2 and 3, the base plate 8 of the present embodiment includes a steam inlet side support portion 81, a steam exhaust side support portion 82, and a shaft beam portion 83.

The steam inlet side support portion 81 supports the steam inlet side bearing portion 71 from below in the vertical direction Dv. The steam inlet side support portion 81 is a member in a columnar shape extending in a width direction Dw orthogonal to the axial direction Da and the vertical direction Dv. The steam inlet side support portion 81 is, for example, H-shaped steel. The steam inlet side support portion 81 is arranged at a position overlapping with the steam inlet side bearing portion 71 when viewed from the vertical direction Dv. The steam inlet side support portion 81 is arranged at a position (position not overlapping) deviated from the steam exhaust port 52 and the steam extraction port 53 when viewed from the vertical direction Dv.

The steam exhaust side support portion 82 supports the steam exhaust side bearing portion 72 from below in the vertical direction Dv. The steam exhaust side support portion 82 is a member in a columnar shape extending in the width direction Dw. The steam exhaust side support portion 82 is, for example, H-shaped steel. The steam exhaust side support portion 82 is arranged side by side with the steam exhaust port 52 when viewed from the width direction Dw. The steam exhaust side support portion 82 is arranged at a position overlapping with the steam exhaust side bearing portion 72 when viewed from the vertical direction Dv. The steam exhaust side support portion 82 is arranged at a position (position not overlapping) deviated from the steam inlet port 51, the steam exhaust port 52, and the steam extraction port 53 when viewed from the vertical direction Dv. The steam exhaust side support portion 82 is arranged apart from the steam inlet side support portion 81 on the steam exhaust side Da2 in the axial direction Da. The steam exhaust side support portion 82 is arranged so as to overlap with the steam exhaust port 52 when viewed from the axial direction Da.

The shaft beam portion 83 extends in the axial direction Da and connects the steam inlet side support portion 81 and the steam exhaust side support portion 82. The shaft beam portion 83 is a member in a columnar shape extending in the axial direction Da. The shaft beam portion 83 is, for example, H-shaped steel. A pair of the shaft beam portions 83 are arranged apart in the width direction Dw. The shaft beam portion 83 is arranged at a position (position not overlapping) deviated from the steam inlet port 51, the steam exhaust port 52, and the steam extraction port 53 when viewed from the vertical direction Dv.

By this, the base plate 8 forms an opening portion 85 surrounded by the pair of shaft beam portions 83, the steam inlet side support portion 81, and the steam exhaust side support portion 82 when viewed from the vertical direction Dv. That is, the base plate 8 is formed as a frame body having a rectangular annular shape with a hollow inside by the pair of shaft beam portions 83, the steam inlet side support portion 81, and the steam exhaust side support portion 82. The steam exhaust port 52 is arranged in a state of being inserted through the opening portion 85. That is, the steam exhaust port 52 is arranged in the opening portion 85 in a state being communicable with the base plate 8 downward in the vertical direction Dv. Therefore, the steam exhaust port 52 and the steam extraction port 53 are arranged so as to penetrate the base plate 8 in the vertical direction Dv when viewed from the width direction Dw. Therefore, the steam exhaust port 52 and the steam extraction port 53 are continuous with the outside of the steam turbine 3 system via a recess portion and an opening that are not illustrated formed in the base 100.

### Configuration of Fixing Member

A plurality of the fixing members 9 can fix the base plate 8 and the base 100. The fixing member 9 is, for example, a bolt. The plurality of fixing members 9 are arranged apart from each other. The plurality of fixing members 9 are arranged apart shifted in the width direction Dw and the axial direction Da in at least a part of a region. Of the plurality of fixing members 9, two of the fixing members 9 closest in the width direction Dw are arranged at positions shifted in the axial direction Da with respect to a region supporting the steam exhaust side bearing portion 72 in the base plate 8. The plurality of fixing members 9 are arranged to be shifted in the axial direction Da in a region overlapping at least with the steam exhaust side bearing portion 72 when viewed from the width direction Dw. The plurality of fixing members 9 of the present embodiment include a plurality of steam inlet side fixing members 91, a plurality of steam exhaust side fixing members 92, and a plurality of beam fixing members 93.

The plurality of steam inlet side fixing members 91 are fixed to the steam inlet side support portion 81 and the base 100. The plurality of steam inlet side fixing members 91 are arranged apart from each other at positions close to four corners of the steam inlet side bearing portion 71 when viewed from the vertical direction Dv. Therefore, four of the steam inlet side fixing members 91 of the present embodiment are arranged apart in the axial direction Da and the width direction Dw. The plurality of steam inlet side fixing members 91 are arranged at positions deviated from the central axis O when viewed from the vertical direction Dv.

The plurality of steam exhaust side fixing members 92 are fixed to the steam exhaust side support portion 82 and the base 100. The plurality of steam exhaust side fixing members 92 are arranged apart from each other in the width direction Dw. The plurality of steam exhaust side fixing members 92 are arranged line-symmetrically with the central axis O as a boundary when viewed from the vertical direction Dv. Two of the plurality of steam exhaust side fixing members 92 closest in the width direction Dw are arranged to be shifted in the axial direction Da in a region on one side in the width direction Dw with respect to the central axis O in the steam exhaust side support portion 82. Therefore, in the region on one side in the width direction Dw with respect to the central axis O in the steam exhaust side support portion 82, the adjacent steam exhaust side fixing members 92 are arranged in a staggered manner so as to alternate with each other when viewed from the vertical direction Dv. In the present embodiment, only the plurality of steam exhaust side fixing members 92 are arranged in a staggered manner in which the positions in the width direction Dw and the axial direction Da are shifted in a state of being apart from each other. Three or more (four in the present embodiment) of the plurality of steam exhaust side fixing members 92 are arranged so as to alternate with each other in the region on one side in the width direction Dw with respect to the central axis O in the steam exhaust side support portion 82. Therefore, eight of the plurality of steam exhaust side fixing members 92 are arranged for one steam exhaust side support portion 82. The plurality of steam exhaust side fixing members 92 are arranged at positions deviated from the central axis O when viewed from the vertical direction Dv. The plurality of steam exhaust side fixing members 92 are arranged at positions overlapping with the steam exhaust port 52 when viewed from the axial direction Da.

The plurality of beam fixing members 93 fix the shaft beam portion 83 and the base 100. The plurality of beam fixing members 93 are arranged in each of the pair of shaft beam portions 83. The plurality of (e.g., seven) of beam fixing members 93 are arranged apart from each other in the axial direction Da with respect to one shaft beam portion 83 when viewed from the vertical direction Dv. The plurality of beam fixing members 93 of the present embodiment are aligned straight in the axial direction Da.

### Actions and Effects

In the steam turbine 3 of the steam turbine 3 system having the above configuration, the steam exhaust port 52 that is large is formed so as to cause the inside and the outside of the casing main body 50 to communicate with each other. Therefore, in the steam turbine 3, since the periphery of the steam exhaust port 52 is formed as a large opening portion, the strength tends to be relatively lower than that in other portions of the casing 5. When the rotor 2 has a higher speed in such the steam turbine 3, a deformation mode of tilting with respect to the vertical direction Dv and the axial direction Da in the vicinity of the steam exhaust port 52 due to vibration occurs. Furthermore, such a deformation mode also affects the steam exhaust side bearing portion 72 arranged at a position close to the steam exhaust port 52. In particular, in the present embodiment, since the steam exhaust port 52 faces downward in the vertical direction Dv, the steam exhaust port 52 is arranged at a position close to a fixed part of the base plate 8 and the base 100 in the vertical direction Dv. Therefore, vibration of the steam exhaust port 52 is easily transmitted to the base plate 8, and deformation generated in the base plate 8 becomes larger.

However, in the present embodiment, the base plate 8 supporting the steam exhaust side bearing portion 72 is fixed to the base 100 by the plurality of fixing members 9. Of the plurality of fixing members 9, two of the fixing members 9 closest in the width direction Dw are arranged to be shifted in the axial direction Da in the region supporting the steam exhaust side bearing portion 72 when viewed from the width direction Dw. That is, the two fixing members 9 apart in the width direction Dw are arranged with respect to the base plate 8 and the base 100 so as to form a virtual plane (line) inclined with respect to the axial direction Da by fixing the base plate 8 and the base 100 at positions shifted in the axial direction Da. Therefore, two of the fixing members 9 apart in the width direction Dw act so as to suppress the deformation mode of falling down with respect to the vertical direction Dv and the axial direction Da in the steam exhaust side support portion 82 arranged in the vicinity of the steam exhaust port 52. Therefore, the base plate 8 is firmly fixed to the base 100 around the steam exhaust port 52 and rigidity of support of the base plate 8 can be secured so as to suppress vibration. This also suppresses vibration of the steam exhaust side bearing portion 72 supported by the base plate 8, and can suppress vibration around the steam exhaust port 52.

The steam exhaust side support portion 82 supporting the steam exhaust side bearing portion 72 and the base 100 are fixed by the plurality of steam exhaust side fixing members 92 when viewed from the axial direction Da. Therefore, deformation of the steam exhaust side support portion 82 supporting the steam exhaust side bearing portion 72 can be directly suppressed at a close position by the plurality of steam exhaust side fixing members 92. Therefore, vibration of the steam exhaust side bearing portion 72 can be stably suppressed at a position close to the steam exhaust port 52 in the vertical direction Dv. This also suppresses vibration of the steam exhaust side bearing portion 72 supported by the base plate 8, and can stably suppress vibration around the steam exhaust port 52.

Three or more of the steam exhaust side fixing members 92 are arranged so as to alternate with each other. Therefore, the plurality of steam exhaust side fixing members 92 are arranged with respect to the base plate 8 and the base 100 so as to form a plurality of virtual planes (lines) inclined in a different orientation with respect to the axial direction Da. Therefore, three or more steam exhaust side fixing members 92 act so as to suppress the deformation mode of tilting with respect to the vertical direction Dv and the axial direction Da in the steam exhaust side support portion 82 arranged in the vicinity of the steam exhaust port 52. Therefore, the base plate 8 is more firmly fixed to the base 100 around the steam exhaust port 52, and high rigidity of support rigidity of the base plate 8 can be secured so as to suppress vibration. This also further suppresses vibration of the steam exhaust side bearing portion 72 supported by the base plate 8, and can further suppress vibration around the steam exhaust port 52.

In addition to the steam exhaust side support portion 82, the base plate 8 includes the steam inlet side support portion 81 supporting the steam inlet side bearing portion 71, and the pair of shaft beam portions 83 connecting the steam inlet side support portion 81 and the steam exhaust side support portion 82. Furthermore, the opening portion 85 is formed at the base plate 8 by the pair of shaft beam portions 83, the steam inlet side support portion 81, and the steam exhaust side support portion 82 when viewed from the vertical direction Dv. The steam exhaust port 52 and the steam extraction port 53 are arranged in a state of being inserted through this opening portion 85. Since the rigidity of the base plate 8 in which the opening portion 85 is formed is very low compared with the base plate 8 in which the opening portion 85 is not formed, the base plate 8 is easily deformed. However, in the present embodiment, the steam exhaust side support portion 82 and the base 100 are fixed by the plurality of steam exhaust side fixing members 92. Therefore, the influence of the rigidity of the base plate 8 as a whole can be suppressed, and high rigidity of support can be secured around the steam exhaust port 52 of the base plate 8 so as to suppress vibration. This also suppresses vibration of the steam exhaust side bearing portion 72 supported by the base plate 8, and can more stably suppress vibration around the steam exhaust port 52.

### Other Embodiments

Although an embodiment of the disclosure has been described in detail with reference to the accompanying drawings, specific configurations are not limited to this embodiment, and design changes and the like without departing from the gist of the disclosure are also included.

Note that in the present embodiment, the steam turbine 3 includes the steam extraction port 53, but is not limited to such a structure. Therefore, the steam turbine 3 need not include the steam extraction port 53. The steam turbine 3 may include an extraction steam inlet port that can supply new steam from the outside of the casing 5 to the steam passing through the main flow path 55.

In the present embodiment, among the plurality of fixing members 9, only the steam exhaust side fixing members 92 arranged in a partial region of the steam exhaust side support portion 82 (region on one side in the width direction Dw with respect to the central axis O in the steam exhaust side support portion 82) are arranged in a staggered manner so as to alternate with each other. However, the arrangement of the plurality of fixing members 9 is not limited to such a structure. For example, the steam exhaust side fixing members 92 arranged in all regions of the steam exhaust side support portion 82 may be arranged in a staggered manner so as to alternate with each other. Furthermore, not only the steam exhaust side fixing members 92 but also the steam inlet side fixing members 91 and the beam fixing members 93 may be arranged in a staggered manner so as to alternate with each other.

In the present embodiment, the base plate 8 includes the opening portion 85, but is not limited to such a shape. Therefore, the base plate 8 may have a shape not having the opening portion 85.

### Supplementary Notes

The steam turbine unit 1 described in the embodiment is understood as follows, for example.

(1) A steam turbine unit 1 according to a first aspect includes: a steam turbine 3 including a rotor 2 extending in an axial direction Da in which a central axis O extends, a casing 5 covering the rotor 2 from an outside in a radial direction Dr with respect to the central axis O, and a bearing portion 7 fixed to the casing 5 and rotatably supporting the rotor 2 with respect to the casing 5; a base plate 8 supporting the steam turbine 3 from below in a vertical direction Dv and fixed on a base 100; and a plurality of fixing members 9 arranged apart from each other and configured to fix the base plate 8 and the base 100, in which the casing 5 includes a steam exhaust port 52 facing downward in the vertical direction Dv and configured to discharge steam to an outside, the bearing portion 7 includes a steam exhaust side bearing portion 72 arranged at a position close to the steam exhaust port 52 in the axial direction Da, the base plate 8 supports the steam exhaust side bearing portion 72, and of the plurality of fixing members 9, two of the fixing members 9 closest in a width direction Dw orthogonal to the vertical direction Dv and the axial direction Da are arranged at positions shifted in the axial direction Da with respect to a region supporting the steam exhaust side bearing portion 72 in the base plate 8.

According to such a configuration, the two fixing members 9 apart in the width direction Dw are arranged with respect to the base plate 8 and the base 100 so as to form a virtual plane (line) inclined with respect to the axial direction Da by fixing the base plate 8 and the base 100 at positions shifted in the axial direction Da. Therefore, two of the fixing members 9 apart in the width direction Dw act so as to suppress the deformation mode of falling down with respect to the vertical direction Dv and the axial direction Da in the member of the base plate 8 arranged in the vicinity of the steam exhaust port 52. Therefore, the base plate 8 is firmly fixed to the base 100 around the steam exhaust port 52 and rigidity of support of the base plate 8 can be secured so as to suppress vibration. This also suppresses vibration of the steam exhaust side bearing portion 72 supported by the base plate 8, and can suppress vibration around the steam exhaust port 52.

(2) The steam turbine unit 1 according to a second aspect is the steam turbine unit 1 of (1), in which the base plate 8 includes a steam exhaust side support portion 82 supporting the steam exhaust side bearing portion 72 from below in the vertical direction Dv and arranged side by side with the steam exhaust port 52 when viewed from the width direction Dw, and the plurality of fixing members 9 include a steam exhaust side fixing member 92 arranged at a position overlapping with the steam exhaust port 52 when viewed from the axial direction Da and fixing the steam exhaust side support portion 82 and the base 100.

According to such a configuration, deformation of the steam exhaust side support portion 82 supporting the steam exhaust side bearing portion 72 can be directly suppressed at a close position by the plurality of steam exhaust side fixing members 92. Therefore, vibration of the steam exhaust side bearing portion 72 can be stably suppressed at a position close to the steam exhaust port 52 in the vertical direction Dv. This also suppresses vibration of the steam exhaust side bearing portion 72 supported by the base plate 8, and can stably suppress vibration around the steam exhaust port 52.

(3) The steam turbine unit 1 according to a third aspect is the steam turbine unit 1 of (2), in which three or more of the plurality of steam exhaust side fixing members 92 are arranged so as to alternate with each other.

According to such a configuration, the plurality of steam exhaust side fixing members 92 are arranged with respect to the base plate 8 and the base 100 so as to form a plurality of virtual planes (lines) inclined in a different orientation with respect to the axial direction Da. Therefore, three or more steam exhaust side fixing members 92 act so as to suppress the deformation mode of tilting with respect to the vertical direction Dv and the axial direction Da in the steam exhaust side support portion 82 arranged in the vicinity of the steam exhaust port 52. Therefore, the base plate 8 is more firmly fixed to the base 100 around the steam exhaust port 52, and high rigidity of support of the base plate 8 can be secured so as to suppress vibration. This also further suppresses vibration of the steam exhaust side bearing portion 72 supported by the base plate 8, and can further suppress vibration around the steam exhaust port 52.

(4) The steam turbine unit 1 according to a fourth aspect is the steam turbine unit 1 of (2) or (3), in which the casing 5 includes a steam inlet port 51 allowing the steam to flow inside at a position apart from the steam exhaust port 52 in the axial direction Da, the bearing portion 7 includes a steam inlet side bearing portion 71 arranged apart from the steam exhaust side bearing portion 72 in the axial direction Da so as to sandwich the steam exhaust port 52 between the steam exhaust side bearing portion 72 and the steam inlet side bearing portion 71 in the axial direction Da, the base plate 8 includes a steam inlet side support portion 81 supporting the steam inlet side bearing portion 71 from below in the vertical direction Dv, and a pair of shaft beam portions 83 extending in the axial direction Da and configured to connect the steam inlet side support portion 81 and the steam exhaust side support portion 82, the base plate 8 forms an opening portion 85 surrounded by the pair of shaft beam portions 83, the steam inlet side support portion 81, and the steam exhaust side support portion 82 when viewed from the vertical direction Dv, and the steam exhaust port 52 is arranged in a state of being inserted through the opening portion 85.

According to such a configuration, the influence of the rigidity of the base plate 8 as a whole can be suppressed, and high rigidity of support can be secured around the steam exhaust port 52 of the base plate 8 so as to suppress vibration. This also suppresses vibration of the steam exhaust side bearing portion 72 supported by the base plate 8 and can more stably suppress vibration around the steam exhaust port 52.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A steam turbine unit comprising:
a steam turbine including a rotor extending in an axial direction in which a central axis extends, a casing covering the rotor from an outside in a radial direction with respect to the central axis, and a bearing portion fixed to the casing and rotatably supporting the rotor with respect to the casing;
a base plate supporting the steam turbine from below in a vertical direction and fixed on a base; and
a plurality of fixing members arranged apart from each other and configured to fix the base plate and the base, wherein
the casing includes a steam exhaust port facing downward in the vertical direction and configured to discharge steam to an outside,
the bearing portion includes a steam exhaust side bearing portion arranged at a position close to the steam exhaust port in the axial direction,
the base plate supports the steam exhaust side bearing portion, and
of the plurality of fixing members, two of the fixing members closest in a width direction orthogonal to the vertical direction and the axial direction are arranged at positions shifted in the axial direction with respect to a region supporting the steam exhaust side bearing portion in the base plate.

2. The steam turbine unit according to claim 1, wherein
the base plate includes a steam exhaust side support portion supporting the steam exhaust side bearing portion from below in the vertical direction and arranged side by side with the steam exhaust port when viewed from the width direction, and
the plurality of fixing members include a steam exhaust side fixing member arranged at a position overlapping with the steam exhaust port when viewed from the axial direction and fixing the steam exhaust side support portion and the base.

3. The steam turbine unit according to claim 2, wherein
three or more of the plurality of steam exhaust side fixing members are arranged so as to alternate with each other.

4. The steam turbine unit according to claim 2, wherein
the casing includes a steam inlet port allowing the steam to flow inside at a position apart from the steam exhaust port in the axial direction,
the bearing portion includes a steam inlet side bearing portion arranged apart from the steam exhaust side bearing portion in the axial direction so as to sandwich the steam exhaust port between the steam exhaust side bearing portion and the steam inlet side bearing portion in the axial direction,
the base plate includes
a steam inlet side support portion supporting the steam inlet side bearing portion from below in the vertical direction, and
a pair of shaft beam portions extending in the axial direction and configured to connect the steam inlet side support portion and the steam exhaust side support portion,
the base plate forms an opening portion surrounded by the pair of shaft beam portions, the steam inlet side support portion, and the steam exhaust side support portion when viewed from the vertical direction, and
the steam exhaust port is arranged in a state of being inserted through the opening portion.
